(19) United States
(12) Patent Application Publication
(10) Pub. No.: US 2026/0122530 A1
(43) Pub. Date: Apr. 30, 2026

(54) Buffer Status Report Design

(71) Applicant: Apple Inc., Cupertino, CA (US)

(72) Inventors: Abdel Karim Ajami, San Jose, CA (US); Jinjing Jiang, Campbell, CA (US); Anuj Batra, Redwood City, CA (US); Yong Liu, Campbell, CA (US); Yanjun Sun, San Diego, CA (US); Jarkko L. Kneckt, Los Gatos, CA (US); Yoel Boger, Shoham (IL); Leonid Epstein, Netanya (IL)

(21) Appl. No.: 19/357,882

(22) Filed: Oct. 14, 2025

Related U.S. Application Data
(60) Provisional application No. 63/712,140, filed on Oct. 25, 2024.

(51) Int. Cl. H04W 28/02

(52) U.S. Cl. CPC H04W 28/0278; H04W 28/0268

(57) ABSTRACT

This disclosure relates to methods for an enhanced buffer status report (BSR) in a wireless local area network system, e.g., such as an IEEE 802.11 based system in a wireless local area network. A wireless device can determine a queue size of a buffer exceeds a reportable limit via a buffer status report, e.g., that can be reported in a quality of server (QoS) control field and/or a BSR subfield of a medium access control (MAC) header of a frame. In addition, the wireless device can report, e.g., based on the determining, a queue size greater than the reportable limit. The queue size greater than the reportable limit can be reported via the frame, e.g., can be carried in an A-control field of the MAC header of the frame.

### PRIORITY DATA

This application claims benefit of priority to U.S. Provisional Application Ser. No. 63/712,140, titled “Buffer Status Report Design”, filed Oct. 25, 2024, which is hereby incorporated by reference in its entirety as though fully and completely set forth herein.

### TECHNICAL FIELD

The present application relates to wireless communication, including techniques and devices for an enhanced buffer status report (BSR) in a wireless local area network system, e.g., an IEEE 802.11 based system.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for devices to an enhanced buffer status report (BSR) in a wireless local area network system, e.g., such as an IEEE 802.11 based system.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links or can be an access point configured to establish a connection with one or more other wireless devices through a WLAN over one or multiple wireless links. In some embodiments, the wireless device can operate in each of the multiple wireless links using a respective radio of the one or more radios.

For example, in some embodiments, a wireless device can determine a queue size of a buffer exceeds a reportable limit via a buffer status report, e.g., that can be reported in a quality of server (QoS) control field and/or a buffer status report subfield of a medium access control (MAC) header of a frame. In addition, the wireless device can report, e.g., based on the determining, a queue size greater than the reportable limit. The queue size greater than the reportable limit can be reported via the frame. In some instances, the queue size greater than the reportable limit can be carried in an A-control field of the MAC header of the frame. As an example, a first portion of the queue size can be reported via the QoS control field or buffer status report subfield and a second portion of the queue size can be reported via the A-control field.

As another example, in some embodiments, a wireless device can determine a queue size of a buffer to report as part of a buffer status report. In addition, the wireless device can report, e.g., based on the determining, the queue size in the buffer status report via a management frame. The management frame can include and/or be an action frame, e.g., such as a QoS action frame, a buffer status report frame, and/or an enhanced buffer status report frame.

As a further example, in some embodiments, a wireless device can determine a queue size of a buffer to report as part of a buffer status report. In addition, the wireless device can report, e.g., based on the determining, the queue size in the buffer status report via a multi-block acknowledgement (M-BA) frame. The queue size can be reported via a block acknowledgement (BA) bitmap field of the M-BA frame. As an example, the BA bitmap field can include a TID field, a scale factor field, an unscaled value field, and/or an unscaled valued extension field.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments.

FIG. 2 is a block diagram illustrating an example wireless device, according to some embodiments.

FIG. 3 is a block diagram illustrating an example network element or access point, according to some embodiments.

FIG. 4 is a block diagram illustrating an example modem or baseband processor, according to some embodiments.

FIG. 5 illustrates an example of a MAC header according to some embodiments.

FIG. 6 illustrates an example of a QoS control field, according to some embodiments.

FIG. 7 illustrates an example of possible values of a queue size subfield of a QoS control field, according to some embodiments.

FIGS. 8, 9, and 10 illustrate examples of A-control subfields, according to some embodiments.

FIG. 11 illustrates an example of a management frame, according to some embodiments.

FIG. 12 illustrates an example M-BA frame, according to some embodiments.

FIGS. 13, 14, and 15 are flowchart diagrams illustrating example methods for performing an enhanced BSR in a wireless local area network system, e.g., such as an IEEE 802.11 based system, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™ Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

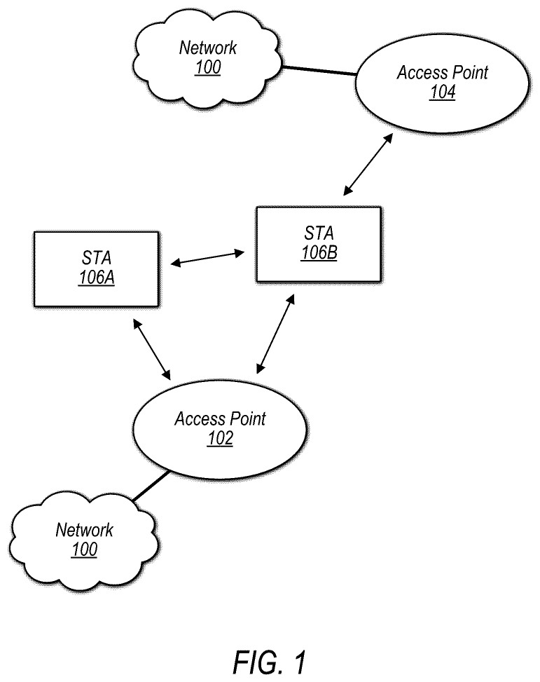

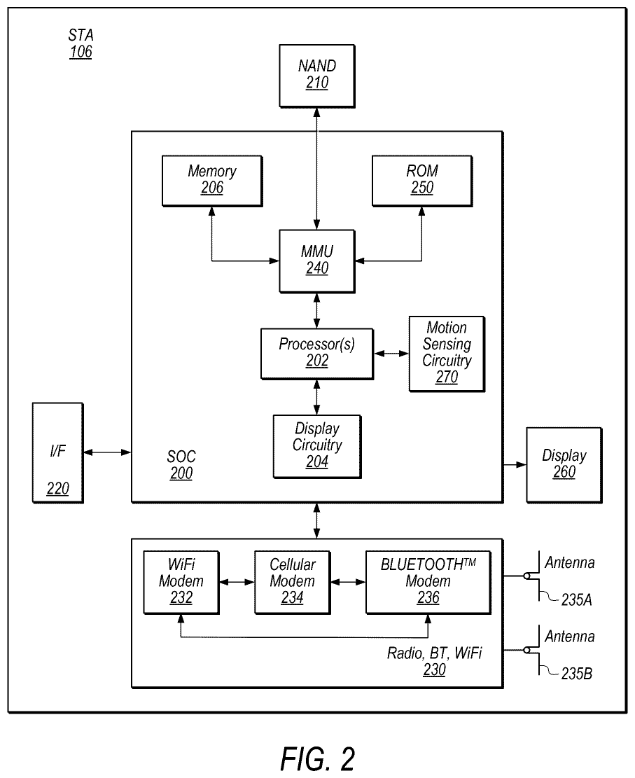

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, AP STAs, UEs, or other WLAN devices.

The STA 106 can be any device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or location-specific service to STA devices 106A-B and similar devices over a geographic area, e.g., via one or more communication technologies. A STA can roam from one AP to another AP directly or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices, such as smart phones or tablets, wearable devices (e.g., smart watches, smart glasses, head-mountable display devices) and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for an enhanced BSR in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash memory 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for an enhanced BSR in a wireless local area network system described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

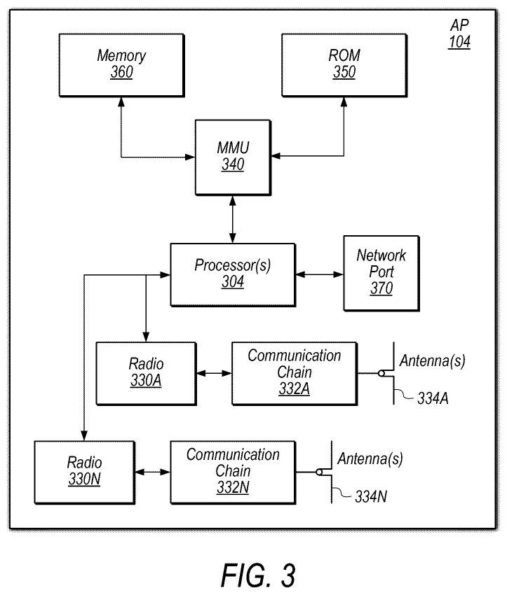

### FIG. 3—Block Diagram of an Access Point

FIG. 3 illustrates an example block diagram of an access point (AP) 104. In some instances (e.g., in an 802.11 communication context), the AP 104 can also be referred to as a station (STA) or an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as an enhanced BSR in a wireless local area network system, e.g., such as an IEEE 802.11 based system, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

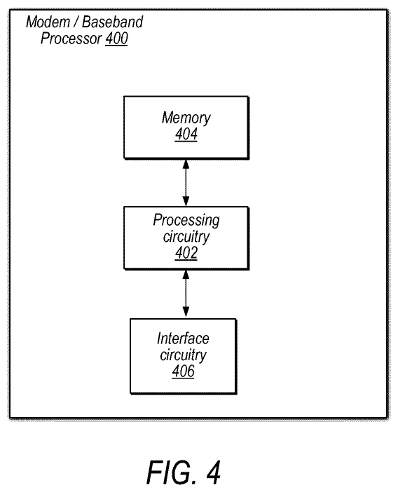

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which can include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as an enhanced BSR in a wireless local area network system, e.g., such as an IEEE 802.11 based system, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

### Enhanced BSR

In current implementations, e.g., since at least the release of IEEE 802.11ax, a buffer status report (BSR) has been supported to assist an access point (AP) in uplink scheduling. For example, the BSR aids the AP in allocation of sufficient uplink resources in trigger frames sent by the AP to wireless stations. In addition, to report the BSR, a wireless station can send the BSR in either a quality of service (QoS) data frame or in a QoS null frame. The wireless station can either contend for medium access and send the QoS frame (either data or null) to the AP (e.g., an unsolicited BSR) or respond to a trigger frame received from the AP with the QoS frame (e.g., a solicited BSR). The BSR can be included in a QoS control field or a BSR control subfield of a medium access control (MAC) header of the QoS frame.

In IEEE 802.11bn, a per traffic identifier (TID) reporting of a larger queue in ultra-high reliability (UHR) has been enabled as an optional feature. The maximum approximated per-TID queue size that can be reported is limited to 2,147,328 octets. There currently is no mechanism to report larger per-TID queue sizes. Therefore, improvements are desired.

Embodiments described herein provide an enhanced buffer status report (BSR). In particular, embodiments described herein provide methods and mechanisms for reporting per-TID queue sizes greater than 2,147,328 octets. For example, in some embodiments, an A-control field in a MAC header can be used to report additional queue sizes in excess of 2,147,328 octets. In other words, a QoS/BSR control field can be used to indicate a buffer and/or queue size of 2,147,328 octets and the A-control field can be used to report an amount of buffer and/or queue size in excess of 2,147,328 octets. As another example, in some embodiments, an A-control field in a MAC header can be used to report a buffer and/or queue size as part of a BSR. In other words, the A-control field can be used to report the buffer and/or queue size regardless of the size of the buffer and/or queue size.

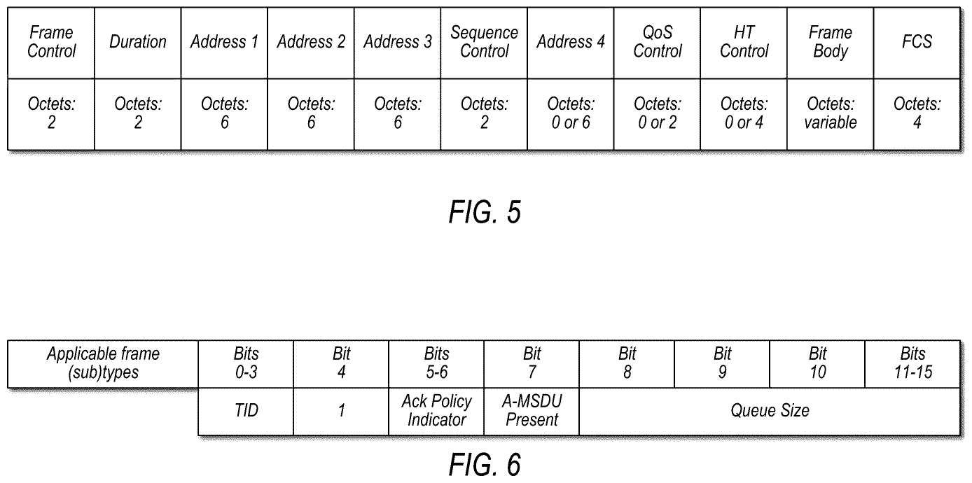

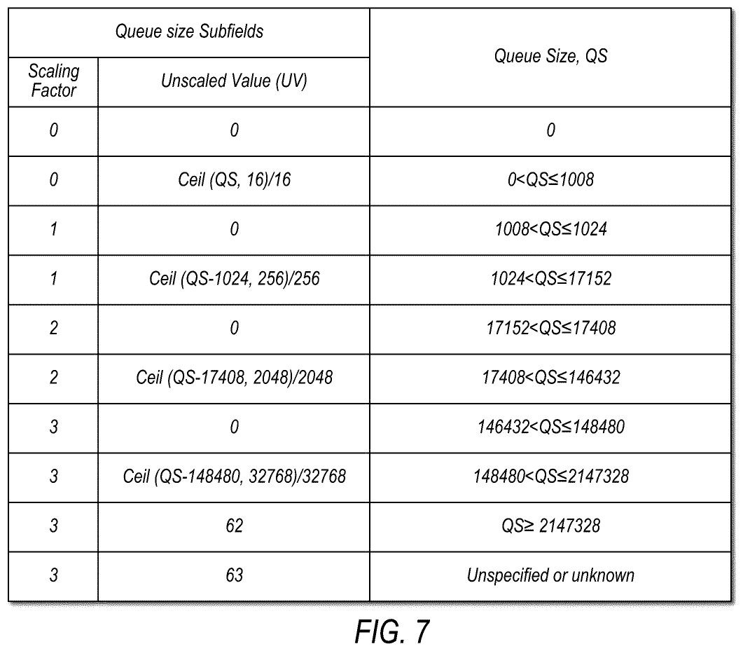

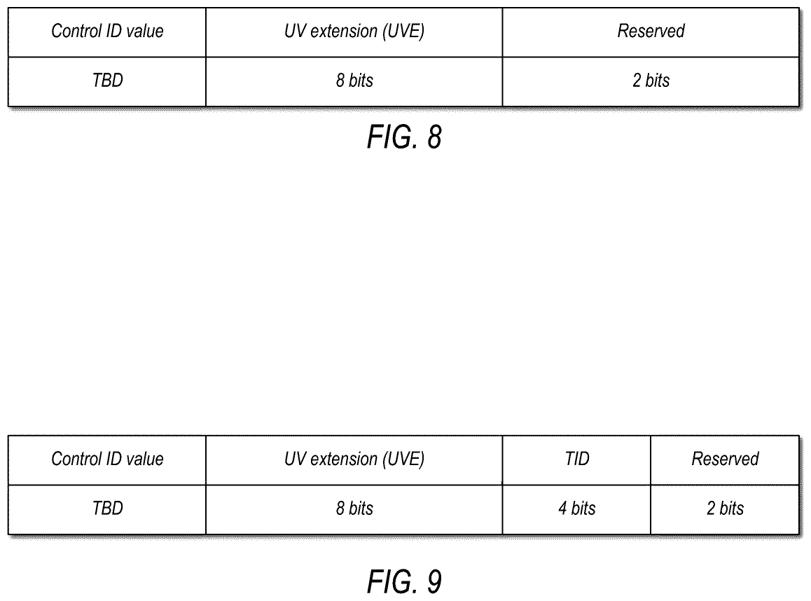

For example, in some instances, a non-AP station (e.g., a wireless station, such as wireless station 106) can report, e.g., in a buffer status report, a queue size greater than a current limit (e.g., 2,147,328 octets) via an A-control field in a MAC header. As shown in FIG. 5, a MAC header can include various fields, such as a frame control field (2 octets), a duration field (2 octets), multiple address fields (up to 6 octets each) (e.g., address fields 1, 2, 3, and 4), a sequence control field (2 octets), a QoS (quality of service) control field (up to 2 octets), a HT field (up to 4 octets), a frame body field (variable is length/size), and/or a frame check sum (FCS) field (4 octets). Further, as shown in FIG. 6, a QoS control field can include up to 4 bits to specify a traffic identifier (TID) (e.g., bits 0-3), up to two bits to indicate an acknowledgement policy indicator (e.g., bits 5-6), one bit to indicate a presence of an aggregate MAC service data unit (A-MSDU) (e.g., bit 7), and up to eight bits to indicate a queue size (e.g., bits 8-15). In addition, FIG. 7 illustrates possible values of a queue size subfield of the QoS control field. As shown, a range of the queue size can be indicated by combinations of values of a scaling factor (SF) and an unscaled value (UE). Thus, to indicate that the non-AP station has a queue size greater than the current limit to report, the non-AP station can set a value of the queue size subfield of, <SF, UV>, the MAC header in a frame to <3, 62>, where 3 indicates a scale factor and 62 indicates an unscaled value. Further, the non-AP station can carry another subfield defined in an A-control field (e.g., a variant of the HT control field), e.g., as illustrated by FIG. 8, in the MAC header of the frame to indicate an additional amount of the queue size that cannot be indicated in the QoS control field. In particular, the additional amount of the queue size can be indicated via an unscaled value extension (UVE) field of the A-control field, where a value of the UVE can be a function of queue size (QS), scale factor (SF), and the current limit (CL), e.g., as shown in equation [1].

$$UVE = ceil ( \frac{Q S - C L}{S F} ) \qquad [ 1 ]$$

In some instances, the scale actor can remain constant between the QS subfield and the A-control frame. In other instances, a scale factor can be indicated via the A-control frame, e.g., via repurposing of the illustrated reserved bits. In some instances, a maximum value of the UVE that can be used in equation [1] can be set to 254, with a value of 255 reserved for a queue size greater than a maximum queue size that can be indicated for a UVE value of 254. In some instances, a size (e.g., number of bits) of the UVE in the A-control field can be specified such that there are remaining bits in the A-control field for the non-AP station to report uplink power headroom in via the A-control field. For example, as shown in FIG. 8, a UVE field in an A-control field can be an 8-bit field, e.g., an 8-bit UV field that can correspond to an extension of a UV field in a QoS QS subfield. In some instances, a maximum reported QS can be limited to 10,470,400. Further, as shown, 2-bits can be reserved, e.g., for later use such as for indicating a scaling factor.

In some instances, such as when an HT control field is present in a medium access control (MAC) protocol data unit (MPDU) MPDU aggregated in an aggregated MPDU (A-MPDU), then all MPDUs of the same frame type (e.g., having the same value for a type subfield of a frame control field) in that A-MPDU contain the same HT control field. Such a scenario can create a challenge when reporting larger queue size for more than one TID since all A-MPDUs are to contain the same HT control field. Note that a non-AP STA can aggregate a BSR of up to 8 TIDs by sending an A-MPDU with QoS Null frames. Hence, in some instances, an A-MPDU can be configured to carry different A-Control values when used to report an enhanced BSR for more than one TID. Such a scheme can be used to for reporting enhanced BSR by a client device in an A-MPDU with multiple QoS Null frames each carrying a single TID BSR. In addition, in some instances, an A-MPDU can be configured to carry different A-control field values when used to report an enhanced BSR from more than one TID. In such instances, a limit on a number of different A-control field values that can be included in the A-MPDU can be defined, e.g., to limit complexity. For example, the limit can be set to 2, 4, and/or 8 TIDs). Further, in some other instances, an A-Control field can be defined that can carry an enhanced BSR that corresponds to a single TID, e.g., as illustrated by FIG. 9. In such instances, all A-Control subfields in an A-MPDU can carry the same content and the A-Control subfield that carries the enhanced BSR can have an additional subfield to indicate the TID that the enhanced BSR corresponds to, e.g., as shown in FIG. 9. As shown, such a field can be 4 bits (or can be more or fewer bits). Note that for other TIDs, the client device (e.g., non-AP STA) can follow baseline (e.g., legacy) mechanism to indicate that it carries more than 2,147,328 octets (if any).

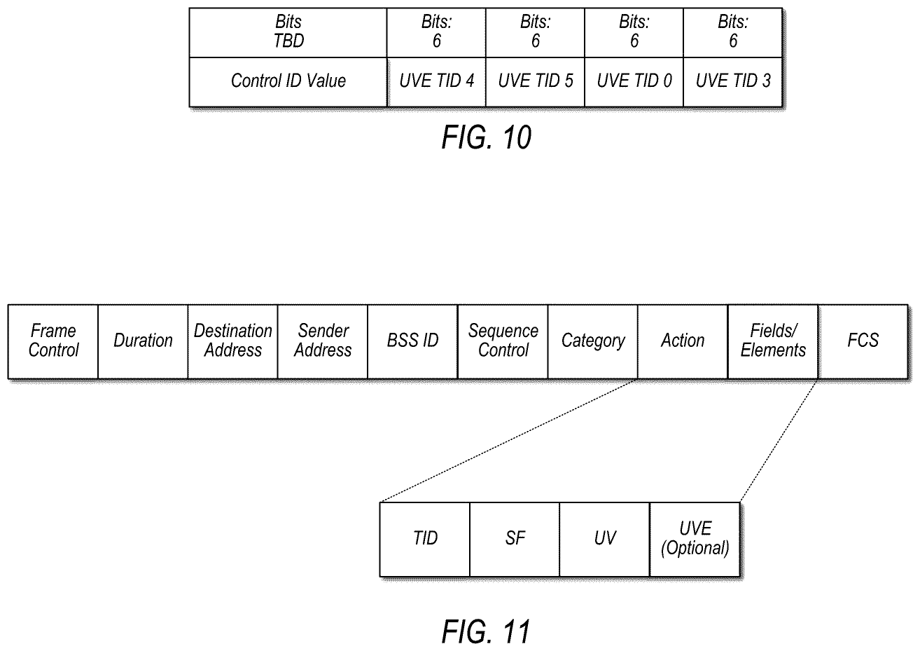

Additionally, in some instances, an A-Control field can be defined that can carry an enhanced BSR that corresponds to multiple TIDs (e.g., more than one TID). In some instances, TIDs that correspond to one or more particular access categories (AC) can be included in the A-control subfield. For example, ACs corresponding to video (AC_VI) and/or voice (AC_VO) can be included in an A-control field. In such a scheme, such TIDs can be reported in order, e.g., TID 4, 5, 6, 7, 8, and so forth. In addition, a value of zero or a special value can be reported when there is no additional queue size for a particular TID. Further, if a fixed scale factor is assumed, 6 bits (instead of 8) can be used for each TID resulting in a total of 24 bits and allowing 2 bits to be reserved for future use (e.g., future definition). Thus, in such instances, an A-Control control information length can be up to 26 bits. As another example, TIDs that correspond to video (AC-VI) and best effort (AC BE) can be included in an A-control field, e.g., since AC_VO can have a shallow buffer and may not require BSR extensions. In such instances, a 6-bit UVE that corresponds to an extension of a UV reported in a QoS QS subfield can be reported on a per TID basis, e.g., as illustrated in FIG. 10. As shown, the A-control subfield can include a control ID value and multiple 6 bit UVE fields, e.g., a UVE TID 4 field, a UVE TID 5 field, a UVE TID 0 field, and a UVE TID 3 field. In some instances, a larger scaling factor (SF) (e.g., a multiple of 32,768) can be used to ensure that a desired maximum queue size value is covered by reporting.

In some instances, a management frame can be used to indicate an additional BSR (and/or an existing BSR). For example, an action frame can be defined for an existing category (e.g., such as a QoS action frame) or a new category to report BSR and/or additional BSR (e.g., enhanced BSR). In such instances, a station can then report BSR/enhanced BSR using such a management frame. FIG. 11 illustrates an example of a management frame for reporting BSR/enhanced BSR, according to some embodiments. As shown, such a management frame can include a frame control field, a duration field, a destination address (DA) field, a sender address (SA) field, a basis service set (BSS) identifier (ID) field, a sequence control field, a category field, an action field, a fields/elements field, and/or a frame check sum (FCS) field. In some instances, as shown, the action and fields/elements fields can include BSR information for one or more TIDs. For example, the BSR information can include a TID field, a scaling factor (SF) field, an unscaled value (UV) field, and/or a UVE field.

In some instances, given that a multi-station block acknowledgement (M-BA) frame is being considered for providing feedback in ultra-high reliability (UHR) mode, an enhanced BSR can be incorporated into an M-BA frame. In some instances, a per association identifier (AID) TID information field can be defined in an M-BA frame to report a BSR and/or an enhanced BSR. Such a scheme can allow for aggregation of BSR/enhanced BSRs for multiple TIDs in one or multiple per AID TID information fields using a single M-BA frame. In addition, such feedback can be aggregated with other per AID TID information fields that carry other feedback, e.g., such as coexistence.

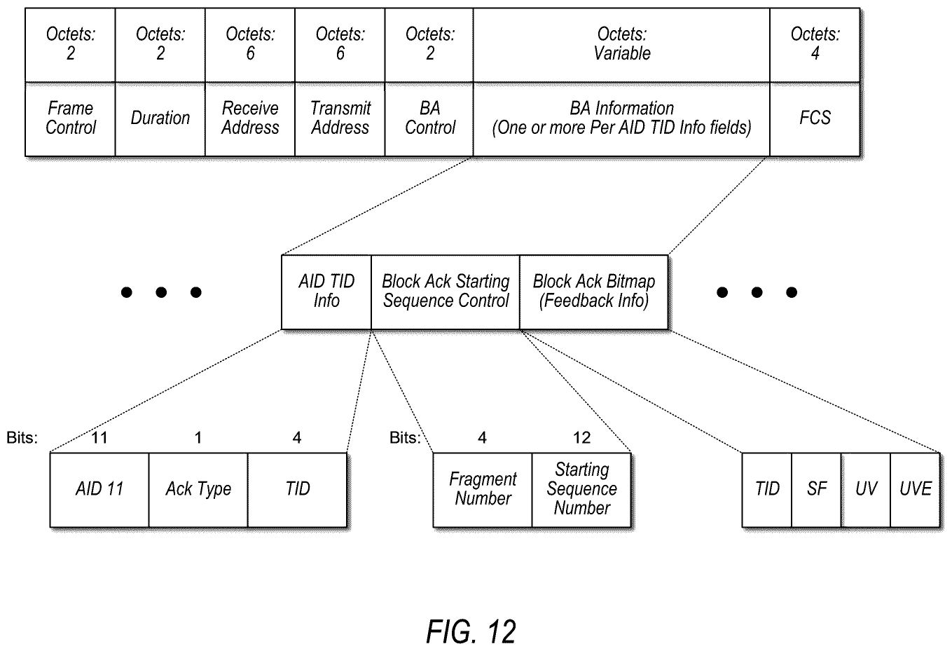

For example, FIG. 12 illustrates an M-BA frame, according to some embodiments. As shown, an M-BA frame can include a frame control field, a duration field, a receiver address (RA) field, a transmitter address (TA) field, a block acknowledgement (BA) control field, a frame check sum (FCS) field, and/or a BA information field. The frame control field can include 2 octets. The duration field can include 2 octets. The RA field can include 6 octets. The TA field can include 6 octets. The BA control field can include 2 octets. The FCS field can include 4 octets. However, in other implementations any/all of these fields can include different numbers of octets. Further, the BA information field can be variable in length. The BA information field can include one or more per AID TID information fields. For example, as shown, a per AID TID information field can include an AID TID information field, a block acknowledgement starter sequence control field, and a block acknowledgement bitmap field containing and/or include feedback information. The AID TID information field can include 16 bits and fields for AID 11, acknowledgement (ACK) type, and TID. In some instances, the ACK type field and/or TID field can be used to indicate a type of per AID TID information for feedback. The block ACK starting sequence control field can include 16 bits, with 4 bits for a fragment number field and 12 bits for a starting sequence number field. In other implementations, one or more other bit lengths can be used. The fragment number field can provide and/or indicate a length of feedback (e.g., a length of an enhanced BSR in a block ACK bitmap subfield). The starting sequence number field can indicate a type of the feedback, e.g., such as that the feedback is enhanced BSR. The block ACK bitmap field can include a TID field, a scale factor (SF) field, an unscaled value (UV) field, and/or an enhanced UV (UVE) field. In some instances, the UVE field can be optional. In some instances, the SF field and the UV field can be used as baseline to calculate an initial queue size and a product of values indicated in the SF field and the UVE field can be added to the baseline to determine the final queue size. In some instances, an SF and UV can be defined to cover queue sizes up to 10,470,400.

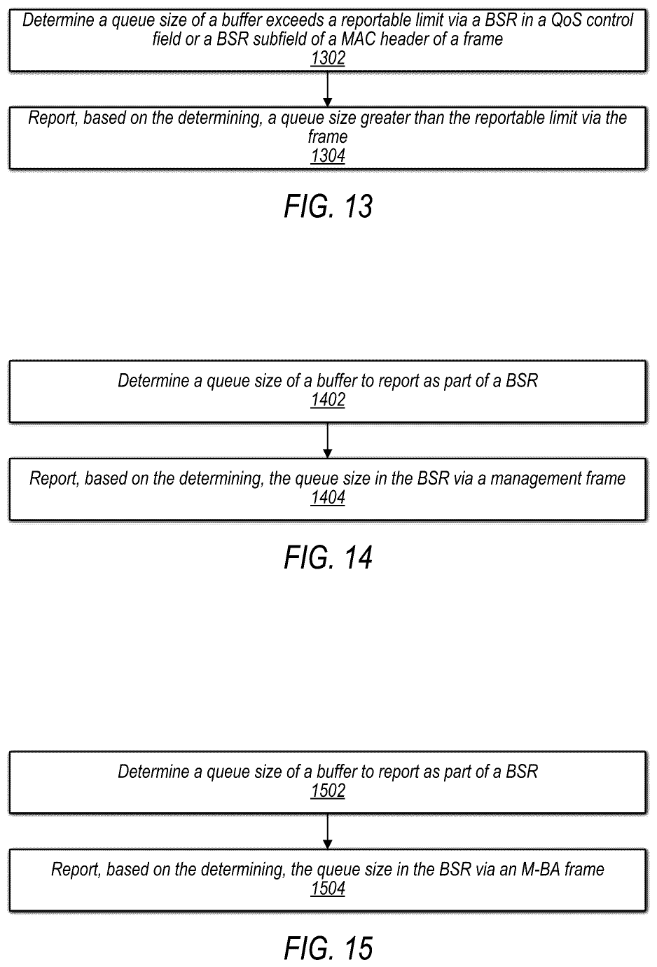

FIGS. 13, 14, and 15 are flowchart diagrams illustrating example methods for performing an enhanced BSR in a wireless local area network system, e.g., such as an IEEE 802.11 based system, according to some embodiments. In various embodiments, some of the elements shown can be performed concurrently, in a different order than shown, can be substituted for by one or more other elements, or can be omitted. Additional elements can also be performed as desired.

Aspects of the elements of FIGS. 13, 14, and 15 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated elements and/or other elements.

Note that while at least some of the elements of FIGS. 13, 14, and 15 are described in a manner relating to the use of communication techniques and/or features associated with IEEE 802.11 specification documents, such description is not intended to be limiting to the disclosure, and aspects of the elements of FIGS. 13, 14, and 15 can be used in any suitable wireless communication system, as desired. Turning to FIG. 13, as shown, the method can operate as follows.

At 1302, a wireless device and/or a baseband processor of a wireless device, such as wireless device 106, can determine a queue size of a buffer exceeds a reportable limit via a buffer status report, e.g., that can be reported in a quality of server (QoS) control field and/or a buffer status report subfield of a medium access control (MAC) header of a frame.

At 1304, the wireless device and/or baseband processor of the wireless device can report, e.g., based on the determining, a queue size greater than the reportable limit.

For example, in some instances, the queue size greater than the reportable limit can be reported via an A-control field of the MAC header of the frame. In some instances, a first portion of the queue size can be reported via the QoS control field or buffer status report subfield. Additionally, a second portion of the queue size can be reported via the A-control field. The first portion can be indicated as a range via a combination of a scale factor field and unscaled value of the queue size field. Further, the second portion can be an additional amount of the queue size greater than the reportable limit. As an example, the second portion can be indicated via an unscaled value extension field. A value of the unscaled value extension field can be a function of the queue size, reportable limit, and scale factor. As another example, the second portion can be indicated via an unscaled value extension field and a scale factor field. In addition, a value of the scale factor field of the A-control field can differ from a value of a scale factor field of the QoS control field or the buffer status report subfield.

In some instances, the A-control field can include an unscaled value extension field and a scale factor field. The queue size can be reported as a function of a value of the unscaled value extension field and a value of the scale factor field. In addition, the A-control field can also include a traffic identifier (TID) field. In some instances, the frame can be a first frame included in an aggregated MAC protocol data unit (A-MPDU). In such instances, the queue size can be a first queue size associated with a first TID and the A-MPDU can also include at least a second frame associated with a second TID. Further, in such instances, the wireless device and/or the baseband processor of the wireless device can determine that a second queue size of a buffer associated with the second TID exceeds the reportable limit via a buffer status report in a QoS control field or a buffer status report subfield of a MAC header of the second frame and report, based on the determining, a second queue size greater than the reportable limit via an A-control field of the MAC header of the second frame.

In some instances, the A-control field can include an unscaled value extension field and a scale factor field. The queue size can be reported as a function of a value of the unscaled value extension field and a value of the scale factor field. In addition, the A-control field can also include a TID field. In some instances, the frame can be a first frame included in an A-MPDU and the queue size can be a first queue size associated with a first TID. In addition, the A-MPDU can also include at least a second frame associated with a second TID and the TID field can indicate a TID associated with the queue size.

In some instances, the A-control field can include an unscaled value extension field and a scale factor field. The queue size can be reported as a function of a value of the unscaled value extension field and a value of the scale factor field. In addition, the A-control field can also include a TID field. In some instances, the frame can be a first frame included in an A-MPDU and the queue size can be a first queue size associated with a first TID. In addition, the A-MPDU can also include at least a second frame associated with a second TID and the TID field can indicate an access category associated with the queue size.

In some instances, the A-control field can include an unscaled value extension field and a scale factor field. The queue size can be reported as a function of a value of the unscaled value extension field and a value of the scale factor field. In addition, the A-control field can also include a TID field. In some instances, the frame can be a first frame included in an A-MPDU and the queue size can be a first queue size associated with a first TID. The A-MPDU can also include at least a second frame associated with a second TID and the TID field can include one or more TID fields. The one or more TID fields can be associated an access category and the queue size can apply to TIDs associated with the access category.

In some instances, the A-control field can include one or more unscaled value extension fields. In such instances, a first unscaled value extension field can correspond to a first TID and at least a second unscaled value extension field can correspond to a second TID. The first traffic TID can be associated with a first access category. In addition, the second traffic TID can be associated with a second access category.

As another example, in some instances, the queue size can be carried in a management frame. The management frame can include and/or be an action frame. The action frame can include and/or be a QoS action frame, a buffer status report frame, and/or an enhanced buffer status report frame. In some instances, the management frame can include at least an action field and an fields/elements field. The action field and the fields/elements field can include information associated with the buffer status report. The information can include a TID field, a scale factor field, an unscaled value field, and/or an unscaled value extension field.

As a further example, in some instances, the queue size can be carrier in a multi-block acknowledgment (M-BA) frame. The queue size can be reported via a BA bitmap field of the M-BA frame. The BA bitmap field can include a TID field, a scale factor field, an unscaled value field, and/or an unscaled valued extension field. In some instances, a value of the scale factor field and a value of the unscaled value field can be used to indicate an initial queue size. In addition, a product of the value of the scale factor field and a value of the unscaled value extension field can be added to the initial queue size to determine the queue size. In some instances, the buffer status report can be per association identifier (AID) TID information field. Further, the buffer status report can be aggregated with other per AID TID information fields to carry additional feedback. The additional feedback can include at least coexistence information.

Turning to FIG. 14, as shown, the method can operate as follows.

At 1402, a wireless device and/or a baseband processor of a wireless device, such as wireless device 106, can determine a queue size of a buffer to report as part of a buffer status report.

At 1404, the wireless device and/or the baseband processor of the wireless device can report, e.g., based on the determining, the queue size in the buffer status report via a management frame. The management frame can include and/or be an action frame. The action frame can include and/or be a QoS action frame, a buffer status report frame, and/or an enhanced buffer status report frame. In some instances, the management frame can include at least an action field and an fields/elements field. The action field and the fields/elements field can include information associated with the buffer status report. The information can include a TID field, a scale factor field, an unscaled value field, and/or an unscaled value extension field.

Turning to FIG. 15, as shown, the method can operate as follows.

At 1502, a wireless device and/or a baseband processor of a wireless device, such as wireless device 106, can determine a queue size of a buffer to report as part of a buffer status report.

At 1504, the wireless device and/or the baseband processor of the wireless device can report, e.g., based on the determining, the queue size in the buffer status report via an M-BA frame. The queue size can be reported via a BA bitmap field of the M-BA frame. The BA bitmap field can include a TID field, a scale factor field, an unscaled value field, and/or an unscaled valued extension field.

In some instances, a value of the scale factor field and a value of the unscaled value field can be used to indicate an initial queue size. In addition, a product of the value of the scale factor field and a value of the unscaled value extension field can be added to the initial queue size to determine the queue size.

In some instances, the buffer status report can be per association identifier (AID) TID information field. Further, the buffer status report can be aggregated with other per AID TID information fields to carry additional feedback. The additional feedback can include at least coexistence information.

Thus, according to the methods of FIGS. 13, 14, and 15, it can be possible to provide an enhanced buffer status report in a WLAN setting, for example to provide better efficiency in reporting queue size. Such techniques can reduce throughput loss and improve power consumption, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for providing a buffer status report, comprising:
determining that a buffer queue size exceeds a reportable limit, based at least on a buffer status report in a quality of server (QoS) control field or a buffer status report subfield of a medium access control (MAC) header corresponding to a frame; and
reporting, based at least on the determining, a buffer queue size greater than the reportable limit.

2. The method of claim 1,
wherein the buffer queue size greater than the reportable limit is indicated in an enhanced buffer status report (EBSR) in an A-control field of the MAC header of the frame.

3. The method of claim 2,
wherein the EBSR comprises at least a queue size indicator field and a traffic identifier (TID) field.

4. The method of claim 3,
wherein a value of the queue size indicator field is based on an unscaled value that is a function of queue size, scale factor, and the reportable limit.

5. The method of claim 3,
wherein the frame is associated with an aggregated MAC protocol data unit (A-MPDU), the queue size is a first queue size associated with a first TID, and the A-MPDU further comprises at least a second frame associated with a second TID.

6. The method of claim 5, further comprising:
determining that a second queue size of a buffer associated with the second TID exceeds the reportable limit via a buffer status report in a QoS control field or a buffer status report subfield of a MAC header of the second frame; and
reporting, based on the determining, a second queue size greater than the reportable limit via an A-control field of the MAC header of the second frame.

7. The method of claim 3,
wherein the TID field:
indicates a TID associated with the queue size:
indicates an access category associated with the queue size; or
comprises one or more TID fields that are associated with an access category, and wherein the queue size applies to TIDs associated with the access category.

8. The method of claim 1,
wherein an A-control field of the MAC header comprises two or more unscaled value extension fields.

9. The method of claim 1,
wherein a first unscaled value extension field corresponds to a first traffic identifier (TID) associated with a first access category and at least a second unscaled value extension field corresponds to a second TID associated with a second access category.

10. An apparatus, comprising:
a memory; and
processing circuitry in communication with the memory and configured to perform operations comprising:
determining a queue size of a buffer exceeds a reportable limit via a buffer status report in a quality of server (QoS) control field or a buffer status report subfield of a medium access control (MAC) header of a frame; and
reporting, based on the determining, a queue size greater than the reportable limit via the frame.

11. The apparatus of claim 10,
wherein the queue size greater than the reportable limit is reported via an enhanced buffer status report (EBSR) comprised in an A-control field of the MAC header of the frame.

12. The apparatus of claim 11,
wherein EBSR comprises at least a queue size indicator field and a traffic identifier (TID) field.

13. The apparatus of claim 12,
wherein a value of the queue size indicator field is based on an unscaled value that is a function of queue size, scale factor, and the reportable limit.

14. The apparatus of claim 12,
wherein the queue size indicator field comprises 8 bits and the TID field comprises 4 bits.

15. The apparatus of claim 10,
wherein the queue size greater than the reportable limit is reported via a block acknowledgement (BA) bitmap field carried in a multi-block acknowledgement (M-BA) frame, and wherein the BA bitmap field comprises a traffic identifier (TID) field, a scale factor field, and at least one of an unscaled value field or an unscaled value extension field.

16. The apparatus of claim 15,
wherein a value of the scale factor field and a value of the unscaled value field is used to indicate an initial queue size when the unscaled value field is present and a product of the value of the scale factor field and a value of the unscaled value extension field is added to the initial queue size to determine the queue size when the unscaled value extension field is present.

17. A wireless device, comprising:
one or more antennas;
one or more radios communicatively coupled to the one or more antennas; and
a baseband processor communicatively coupled to the one or more radios;
wherein the baseband processor is configured to cause the wireless device to perform operations comprising:
determining that a buffer queue size exceeds a reportable limit based at least on a buffer status report in a quality of server (QoS) control field or a buffer status report subfield of a medium access control (MAC) header of a frame; and
reporting, based at least on the determining, a buffer queue size greater than the reportable limit.

18. The wireless device of claim 17,
wherein the buffer queue size greater than the reportable limit is indicated in an enhanced buffer status report (EBSR) in an A-control field of the MAC header of the frame.

19. The wireless device of claim 18,
wherein EBSR comprises at least a queue size indicator field and a traffic identifier (TID) field, wherein the queue size indicator field comprises 8 bits and the TID field comprises 4 bits.

20. The wireless device of claim 19,
wherein a value of the queue size indicator field is based on an unscaled value that is a function of queue size, scale factor, and the reportable limit.
